(19) United States
(12) Patent Application Publication
(10) Pub. No.: US 2007/0229023 A1
(43) Pub. Date: Oct. 4, 2007

(54) Charging multiple types of battery packs

(76) Inventors: Peter T. Li, Portland, OR (US); Don J. Nguyen, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/396,013

(22) Filed: Mar. 31, 2006

(51) Int. Cl. H02J 7/00

(52) U.S. Cl. 320/107

(57) ABSTRACT

The current embodiment provides a notebook system the capability of charging various types of battery packs with varying technologies and mAH capacities. The embodiment may accommodate a wide array of charge profiles from the various types of batteries. It may be implemented in power delivery systems, such that two signals, V_{CHRM} and I_{CHRM}, are used to realize various battery charge profiles.

### BACKGROUND INFORMATION

Computer systems are becoming increasing pervasive in our society, including everything from small handheld electronic devices, such as personal data assistants and cellular phones, to application-specific electronic devices, such as set-top boxes, digital cameras, and other consumer electronics, to medium-sized mobile systems such as notebook, sub-notebook, and tablet computers, to desktop systems, servers and workstations. Computer systems typically include one or more processors. A processor manipulates and controls the flow of data in a computer by executing instructions.

To provide more powerful computer systems for consumers, processor designers strive to continually increase the operating speed of the processor. Unfortunately, as processor speed increases, the power consumed by the processor tends to increase as well. Historically, the power consumed by a computer system has been limited by two factors. First, as power consumption increases, the computer tends to run hotter, leading to thermal dissipation problems. Second, the power consumed by a computer system may tax the limits of the power supply used to keep the system operational, reducing battery life in mobile systems and diminishing reliability while increasing cost in larger systems.

Conventional notebook computers usually require its consumer to download additional software or modify hardware in the event that another battery technology, different from an originally intended technology, is used by the notebook computer. Thus, battery chargers used in current notebook systems are usually limited to one particular charge profile. For instance, if a consumer substitutes Nickel batteries for a Lithium-Ion (Li-ion) battery, requiring a constant voltage and utilizing well known voltage detection and charging time-out technique to determine when to terminate its charging, it is very likely that the consumer would have to at least upgrade its software and/or hardware to properly charge the Li-ion battery.

By having the upgrade, this limits one platform to charge one particular type of battery with a particular range of capacity since it takes a different charge profile to properly charge batteries with different technologies. Therefore requiring, any change of the charge profile to redesign of the platform.

The present invention addresses this and other issues associated with the prior art.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the inventions.

FIG. 1 illustrates a block diagram of a computer system in accordance with an embodiment.

FIG. 2 illustrates a circuit schematic of a battery switching circuit in accordance to one embodiment.

FIG. 3 illustrates a current-voltage curve for battery charging current in accordance to an embodiment.

FIG. 4 illustrates a voltage-voltage curve for battery charging voltage in accordance to an embodiment.

### DETAILED DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well-known devices, circuits, and methods are omitted so as not to obscure the description of the present invention with unnecessary detail.

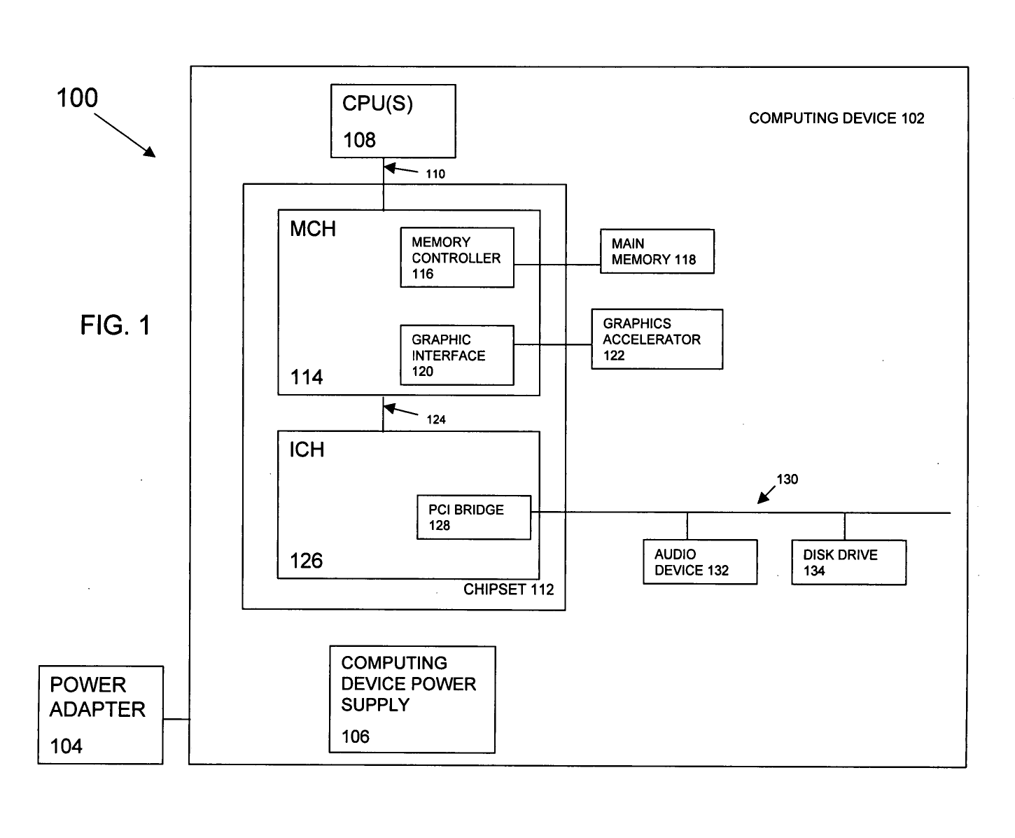

FIG. 1 illustrates a block diagram of a computer system 100 in accordance with an embodiment. The computer system 100 includes a computing device 102 and a power adapter 104 (e.g., to supply electrical power to the computing device 102). The computing device 102 may be any suitable computing device such as a laptop (or notebook) computer, a personal digital assistant, a desktop computing device (e.g., a workstation or a desktop computer), a rack-mounted computing device, and the like.

Electrical power may be provided to various components of the computing device 102 (e.g., through a computing device power supply 106) from one or more of the following sources: one or more battery packs, an alternating current (AC) outlet (e.g., through a transformer and/or adaptor such as a power adapter 104), automotive power supplies, airplane power supplies, and the like. In one embodiment, the power adapter 104 may transform the power supply source output (e.g., the AC outlet voltage of about 110 VAC to 240 VAC) to a direct current (DC) voltage ranging between about 7 VDC to 12.6 VDC. Accordingly, the power adapter 104 may be an AC/DC adapter.

The computing device 102 also includes one or more central processing unit(s) (CPUs) 108 coupled to a bus 110. In one embodiment, the CPU 108 is one or more processors in the Pentium® family of processors including the Pentium® II processor family, Pentium® III processors, Pentium® IV processors available from Intel® Corporation of Santa Clara, Calif. Alternatively, other CPUs may be used, such as Intel's Itanium®, XEON™, and Celeron® processors. Also, one or more processors from other manufactures may be utilized. Moreover, the processors may have a single or multi core design.

A chipset 112 is also coupled to the bus 110. The chipset 112 includes a memory control hub (MCH) 114. The MCH 114 may include a memory controller 116 that is coupled to a main system memory 118. The main system memory 118 stores data and sequences of instructions that are executed by the CPU 108, or any other device included in the system 100. In one embodiment, the main system memory 118 includes random access memory (RAM); however, the main system memory 118 may be implemented using other memory types such as dynamic RAM (DRAM), synchronous DRAM (SDRAM), and the like. Additional devices may also be coupled to the bus 110, such as multiple CPUs and/or multiple system memories.

The MCH 114 may also include a graphics interface 120 coupled to a graphics accelerator 122. In one embodiment, the graphics interface 120 is coupled to the graphics accelerator 122 via an accelerated graphics port (AGP). In an embodiment, a display (such as a flat panel display) may be coupled to the graphics interface 120 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 124 couples the MCH 114 to an input/output control hub (ICH) 126. The ICH 126 provides an interface to input/output (I/O) devices coupled to the computer system 100. The ICH 126 may be coupled to a peripheral component interconnect (PCI) bus. Hence, the ICH 126 includes a PCI bridge 128 that provides an interface to a PCI bus 130. The PCI bridge 128 provides a data path between the CPU 108 and peripheral devices. Additionally, other types of I/O interconnect topologies may be utilized such as the PCI Express™ architecture, available through Intel® Corporation of Santa Clara, Calif.

The PCI bus 130 may be coupled to an audio device 132 and one or more disk drive(s) 134. Other devices may be coupled to the PCI bus 130. In addition, the CPU 108 and the MCH 114 may be combined to form a single chip. Furthermore, the graphics accelerator 122 may be included within the MCH 114 in other embodiments.

Additionally, other peripherals coupled to the ICH 126 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like. Hence, the computing device 102 may include volatile and/or nonvolatile memory.

Currently, notebook computers usually require its consumer to download additional software or modify hardware in the event that another battery technology, different from an originally intended technology, is used by the notebook computer. The power adapter 104 may supply power to an electrical load through VDC and charge a battery through a battery charger. The battery charger usually starts to charge, for example, Li-ion batteries, with a constant current.

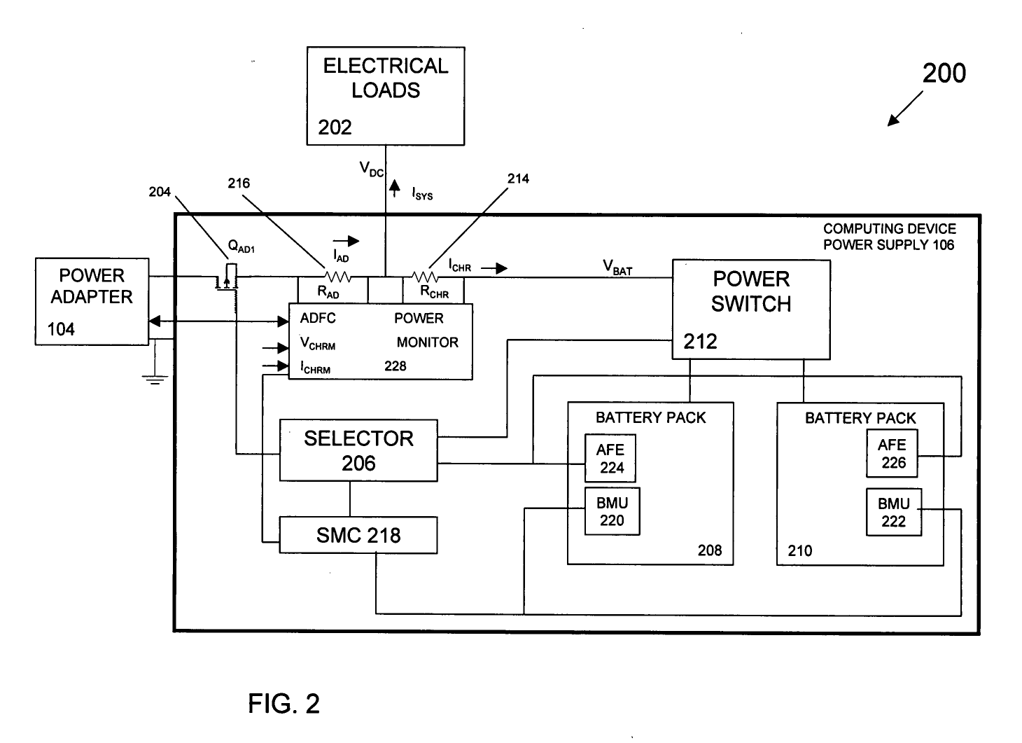

The current embodiment provides a notebook system the capability of charging various types of battery packs with varying technologies and mAH capacities. This embodiment may accommodate a wide array of charge profiles from the various types of batteries. It may be implemented in either conventional power delivery systems or IMPAM enabled systems. Two signals, V_{CHRM} and I_{CHRM}, are used to realize various battery charge profiles. In conventional systems, the battery charger controller IC receives the signals V_{CHRM} and I_{CHRM} to control the battery charger so that the charge profile is realized. In the current embodiment, as described in FIG. 2, a power monitor receives the signals to control the battery charger so that the charge profile is realized.

FIG. 2 illustrates a circuit schematic of a power system 200 in accordance with one embodiment. The power system 200 includes the power adapter 104 and the computing device power supply 106 discussed with reference to FIG. 1. In one embodiment, the power system 200 illustrates further details regarding the computing device power supply 106 of FIG. 1.

The power system 200 includes electrical loads 202 coupled to the computing device power supply 106. The electrical loads 202 may represent various components of the computing device 102 of FIG. 1 which derive their power from the power adapter 104 (e.g., through the computing device power supply 106). For example, the electrical loads 202 may represent power usage by items 108-134 discussed with reference to FIG. 1 and a platform associated with those items. In one embodiment, one or more DC to DC voltage regulators may be utilized between the computing device power supply 106 and the electrical loads 202 (not shown), e.g., to regulate the voltage provided to the various components of the computing device 102. In another embodiment, the electrical loads 202 may represent power usage of a platform.

As illustrated in FIG. 2, the computing device power supply 106 may include a transistor 204 (Q_{AD1}) to switch the voltage potential provided by the power adapter 104. The negative voltage potential terminal of power adapter 104 is also connected to the power system 200, and may be connected to ground. The transistor 204 may be any suitable transistor including a power transistor, such as a field effect transistor (FET), a metal oxide silicon FET (MOSFET), and the like. The gate of the transistor 204 (Q_{AD1}) is coupled to a selector 206 (alternatively, power monitor 228) to control the flow of current from the power adapter 104 into the computing device power supply 106.

The selector 206 is also coupled to one or more battery packs (208 and 210) and a power switch 212. The battery packs (208-210) may provide reserve power for the electrical loads 202, e.g., when the power adapter 104 is disconnected from the computing device power supply 106 and/or a power source (such as those discussed with reference to FIG. 1). The power switch 212 is coupled to the battery packs (208-210) and controlled by the selector 206 to switch power to and from the battery packs (208-210) on or off. For example, to provide reserve power (from the battery packs 208 and 210) to the electrical loads 202, e.g., through a resistor 214 (R_{CHR}), the selector 206 may switch on the power switch 212. Alternatively, when charging the battery packs (208-210), the selector 206 may turn on the power switch 212 to provide power to the battery packs (208-210) through the transistor 204 (Q_{AD1}), a resistor 216 (R_{AD}), and the resistor 214 (R_{CHR}).

The power adapter 104 output current I_{AD} may be determined through resistor R_{AD} 216. In the battery pack 208, 210 current I_{CHR} may be determined by resistor R_{CHR} 214. Thus, the current going to the electrical loads 202 is I_{SYS}. Therefore, the power adapter 104 output current I_{AD} is equal to the total of the battery pack 208, 210 current I_{CHR} and the electrical load 202 current I_{SYS}.

In this embodiment, the selector 206 may switch the flow of power from the power adapter 104 on or off based on the state of the battery packs (208-210) and/or the electrical loads. For example, if the battery packs (208-210) are fully charged and the electrical loads 202 are off (e.g., the computing device 102 is shut down), the selector 206 may switch off the flow of current from the power adapter 104 into the computing device power supply 106. Alternatively, if the battery packs (208-210) are to be charged and the electrical loads 202 are off (e.g., the computing device 102 is shut down), the selector 206 may switch on the transistor 204 and the power switch 212 to allow the flow of current from the power adapter 104 into the battery packs (208-210). In this embodiment, the power switch 212 may include a suitable transistor controlled by the selector 206 for each battery pack (208-210), including a power transistor, such as a FET, a MOSFET, and the like.

Furthermore, the selector 206 may determine when to switch between a plurality of battery packs (208-210). For example, when a battery pack (208 or 210) is removed from the computing device power supply 106, the selector 206 may switch to any remaining battery packs. The power switch 212 may be utilized to avoid safety issues (e.g., by having exposed battery terminal pins) when a battery pack is removed.

The computing device power supply 106 also includes a system management controller (SMC) 218 which is coupled to the battery packs (208-210) to monitor the current flow into and out of the battery packs to determine the charge level and capacity of each battery pack. In one embodiment, each battery pack may include a battery management unit (BMU) (220 and 222) to monitor the current flow through the battery pack. The SMC 218 is also coupled to the selector 206 to communicate the battery pack charge level and capacity information. As stated previously, the power monitor module 228 manages power demand from the electrical loads 202. The power information may be provided by the power monitor 228 to the computing device power supply 106. The system power limit may be communicated to the power monitor module 228 through the system management controller (SMC) 218.

The selector 206 is coupled to an analog front end (AFE) (224 and 226) within each battery pack, e.g., to switch the flow of power between the battery packs and the power switch 212. In an embodiment, the AFEs (224 and 226) are coupled to the power switch through one or more suitable transistors, including a power transistor, such as a FET, a MOSFET, and the like.

The computing device power supply 106 additionally includes a power monitor module 228 coupled to measure the voltage across the resistors 214 and 216. In one embodiment, the resistors 214 and 216 have fixed values. The power monitor module 228 may be coupled to measure the current flow through the resistors 214 and 216. For example, the power monitor module 228 may monitor the total system power consumption (e.g., by measuring the voltage across the resistor 216) and the battery pack charging power (e.g., by measuring the voltage across the resistor 214).

The power monitor module 228 is coupled to the power adapter 104 through an adapter feedback control (ADFC) pin 231. The ADFC pin 231 may detect the power rating of the power adapter 104. The power to the battery packs 208, 210 and the electrical loads 202 maybe controlled by adjusting the current input to the power adapter 104 through the ADFC pin 231.

In an IMPAM system, as illustrated in FIG. 2, the power monitor 228 receives the signals V_{CHRM} and I_{CHRM} to control the adapter/charger such that the charge profile is realized. In both systems, battery voltage and charging current are monitored.

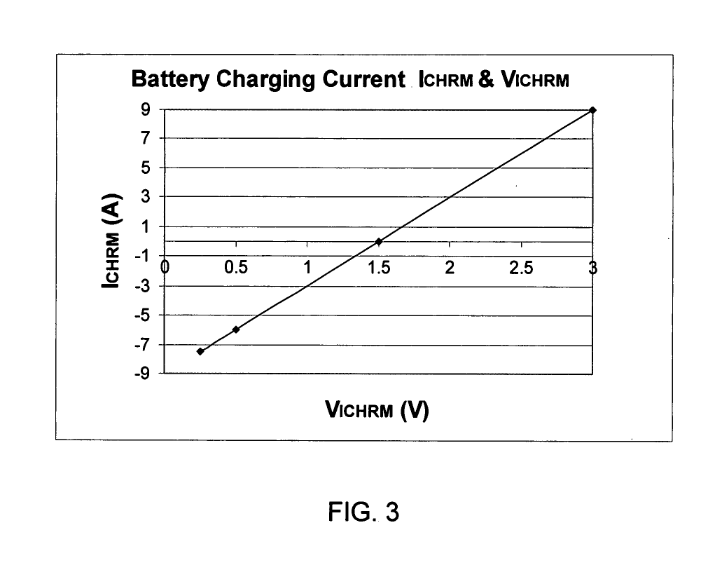

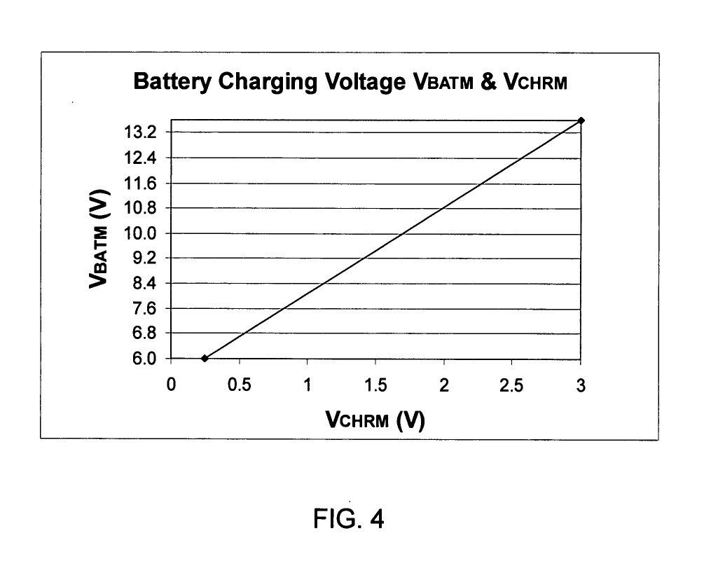

Referring now to FIGS. 3 and 4, respectively FIG. 3 is one example of a current-voltage chart of controlling the charging current via the voltage at I_{CHRM}. FIG. 4 is one example of a voltage-voltage chart of controlling the charging voltage via the voltage at V_{CHRM}. In this embodiment, either the voltage at I_{CHRM} or the voltage at V_{CHRM} is zero at one given instance. A zero voltage at I_{CHRM} indicates that the charge profile is not in constant current mode, rather the voltage at V_{CHRM} took control of the charge profile and the battery pack is being charged in constant voltage mode.

Likewise a zero voltage at V_{CHRM} indicates the charge profile is not in constant voltage mode, the voltage at I_{CHRM} took control of the charge profile and the battery pack is being charged in constant current mode. Therefore, any charge profiles, for instance IE, IEI, IEIE, may be implemented. The current and voltage at different charge stage may be controlled to fit the battery pack requirements. The charge profiles may be modified real time to meet battery pack conditions without reworking the platform. The charge profile may be communicated to the battery charger controller or power monitor through SMC bus or any other suitable means.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A system comprising:
a nonvolatile memory device coupled to a computing device to store data;
a plurality of battery packs;
a switch; and
a power module coupled to the plurality of battery packs and switch, wherein the power module to receive signals to control the switch so that charge profile is realized on the plurality of battery packs.

2. The system of claim 1, wherein the current input to the adapter is modified through a feedback pin.

3. The system of claim 2, wherein the adapter output voltage is increased by modifying current through the feedback pin.

4. The system of claim 2, wherein the adapter output voltage is to be controlled by the current from the system through the feedback pin.

5. The system of claim 1, wherein the computing device comprises volatile memory selected from a group comprising RAM, DRAM, and SRAM.

6. The system of claim 1, wherein the nonvolatile memory device is selected from a group comprising a hard drive and a floppy disk drive.

7. A power supply computing circuit comprising:
a power module;
an adapter coupled to the power module;
a switch coupled to the power module; and
a plurality of battery packs coupled to the power module and the switch, wherein the power module to receive signals to control the switch such that charge profile is realized.

8. The circuit of claim 7 further comprising a controller to monitor the current flow into and out of the battery.

9. The circuit of claim 8, wherein the controller to determine the charge level and capacity of each battery.

10. The circuit of claim 9, wherein the power module includes a feedback pin to communicate with the adapter.

11. The circuit of claim 10, wherein the current input to the adapter is modified through a feedback pin.

12. The circuit of claim 11, wherein the adapter output voltage is increased by modifying current through the feedback pin.

13. The circuit of claim 12, wherein the adapter output voltage is controlled by the current from the circuit through the feedback pin.

14. The circuit of claim 9, wherein power to the battery is controlled by adjusting the current input to the adapter through the feedback pin.

15. The circuit of claim 7 further comprising a transistor to switch voltage potential provided by the adapter.

16. The circuit of claim 15, wherein a gate of the transistor is coupled to the power module to control flow of current from the adapter to the circuit.

17. A method comprising:
performing a monitoring operation to determine whether a battery requires charging by a power module;
performing a charging operation on the battery in the event that the battery requires charging; and
performing a controlling operation to determine if charge profile is realized.

18. The method of claim 17, further comprising discharging the battery.

19. The method of claim 18, modifying current input to a power adapter through a feedback pin in accordance with power consumption of a computing device.

20. The method of claim 19 further comprising increasing adapter output voltage by modifying current through the feedback pin.

21. The method of claim 20, further comprising adjusting charging/discharging activities of the battery.
